(19) United States
(12) Patent Application Publication
(10) Pub. No.: US 2010/0094857 A1
(43) Pub. Date: Apr. 15, 2010

(54) INFORMATION PROCESSING APPARATUS AND INFORMATION PROCESSING METHOD

(75) Inventor: Makoto Tomita, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/578,418

(22) Filed: Oct. 13, 2009

(30) Foreign Application Priority Data
Oct. 14, 2008 (JP) 2008-265790

(51) Int. Cl. G06F 7/10; G06F 17/30; G06F 3/048

(52) U.S. Cl. 707/706; 707/E17.01; 707/E17.014; 715/856

(57) ABSTRACT

The present invention relates to a method for easily finding target data even when a plurality of data having similar data information satisfy a search condition. An information processing apparatus includes a matched data information acquisition unit configured to search for data stored in a storage device based on a search condition to acquire information about matched data which satisfies the search condition, an associated data information acquisition unit configured to acquire information about associated data which is associated with the matched data, and a display unit configured to display a screen which includes the information about the matched data acquired by the matched data information acquisition unit and the information about the associated data acquired by the associated data information acquisition unit.

### FIELD OF THE INVENTION

1. Field of the Invention

The present invention relates to an information processing apparatus and a method for displaying a search result in an information processing method.

2. Description of the Related Art

Conventionally, when a user searches for a target file from a file management system, the user specifies a search condition, executes a search operation, and selects the target file from a “list of files which satisfy the specified condition” which is output by the file management system. However, when there are many files which satisfy the specified condition, the list of files which satisfy the specified condition includes a plurality of files which have similar display items, such as a file name and updated date (hereinafter referred to as search result display items). As a result, there arises a problem that it becomes difficult for the user to determine which file is the target file.

Taking this problem into consideration, some conventional methods for displaying a file search result have a devised process for displaying a file storage location in a comprehensible form. (For example, refer to Japanese Patent Application Laid-Open No. 2001-43231.) File management systems which display contents of files in thumbnail images for easier file locating are commonly used.

### SUMMARY OF THE INVENTION

The present invention relates to a method for easily finding target data even when there is a plurality of pieces of data which has similar data information.

According to an aspect of the present invention, an information processing apparatus includes a matched data information acquisition unit configured to search for data stored in a storage device based on a search condition to acquire information about matched data which satisfies the search condition, an associated data information acquisition unit configured to acquire information about associated data which is associated with the matched data, and a display unit configured to display a screen which includes the information about the matched data acquired by the matched file information acquisition unit and the information about the associated data acquired by the associated data information acquisition unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an exemplary hardware configuration of a personal computer (PC) which constitutes a file management system.

FIG. 2 illustrates an exemplary software configuration of the PC which constitutes the file management system.

FIG. 3 schematically illustrates an exemplary data structure used for file storage in a file system.

FIG. 4 illustrates an exemplary data structure of a folder and a file.

FIG. 5 illustrates exemplary screen display of each folder illustrated in FIG. 3 by using a file operation module (not illustrated) in the file management system in FIG. 2.

FIG. 6 is a flow chart illustrating exemplary processing for file search and search result display.

FIG. 7 is a flow chart illustrating exemplary processing for acquiring file information of other files.

FIG. 8 schematically illustrates screen display of a search result created by a file search module.

FIG. 9 schematically illustrates an exemplary search result which is displayed differently from the one in FIG. 8 by the file search module.

FIG. 10 schematically illustrates an exemplary search result which is displayed differently from the ones in FIGS. 8 and 9 by the file search module.

FIG. 11 is a flow chart illustrating exemplary processing for displaying a search result.

FIG. 12 illustrates an exemplary system configuration of the file management system.

FIG. 13 illustrates an exemplary software configuration of a client PC and a file server which constitute the file management system.

FIG. 14 illustrates an exemplary data structure of a file.

FIG. 15 is a flow chart illustrating exemplary processing for acquiring file information of other files.

### DESCRIPTION OF THE EMBODIMENTS

Various exemplary embodiments, features, and aspects of the invention will be described in detail below with reference to the drawings.

A first exemplary embodiment attains all functions of a file management system by using an ordinary information processing apparatus (PC).

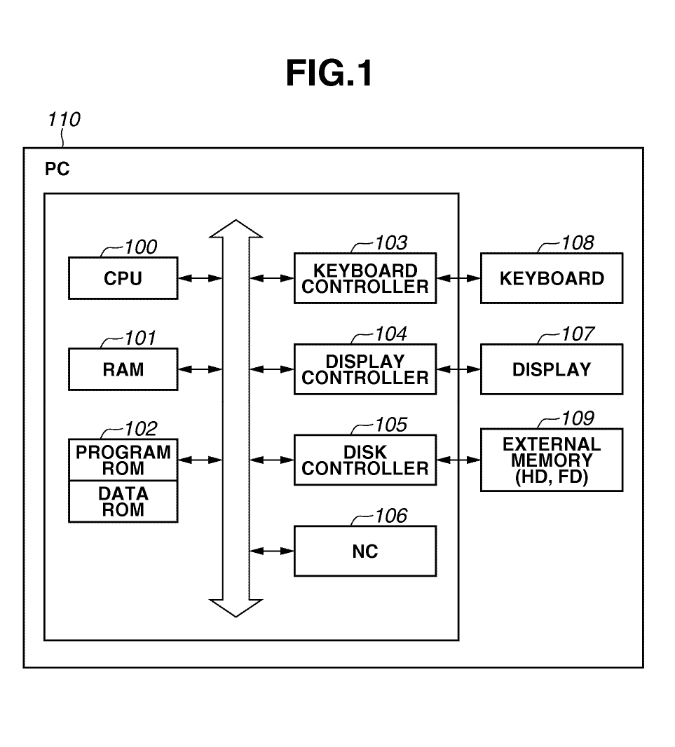

FIG. 1 illustrates an exemplary hardware configuration of a PC which constitutes the file management system. The hardware configuration illustrated in FIG. 1 is equivalent to a hardware configuration of ordinary information processing apparatuses, and the hardware configuration of ordinary information processing apparatuses can be applied to a client PC 110 according to the present exemplary embodiment.

Referring to FIG. 1, a CPU 100 executes an operating system (OS) or an application program stored in a program read-only memory (ROM) 102 or loaded from a hard disk 109 into a random access memory (RAM) 101. Processing of each flowchart to be mentioned below is attained when the CPU 100 executes relevant programs.

The RAM 101 serves as a main memory or a work area for the CPU 100. A keyboard controller 103 controls inputs from a keyboard 108, a mouse, and other pointing devices (not illustrated). A display controller 104 controls various display modes of a display 107. A disk controller 105 controls data access for the hard disk (HD) 109 and a floppy disk drive (FD) which store various pieces of data. A network controller (NC) 106 is connected to a network to perform control processing of communications with other apparatuses connected to the network.

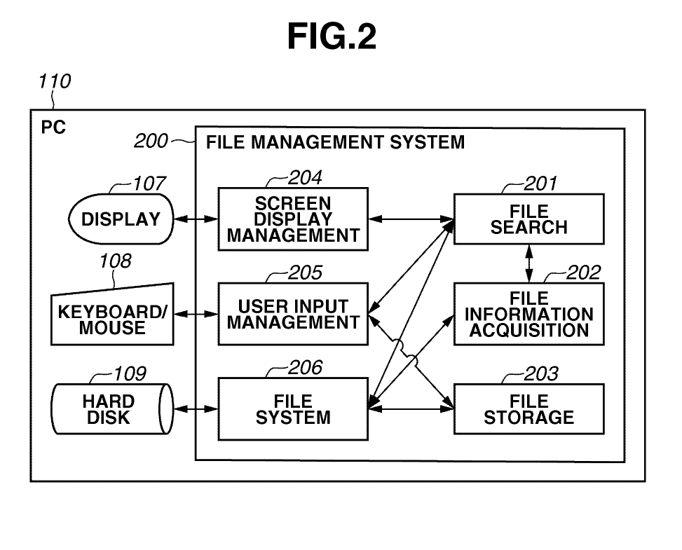

FIG. 2 illustrates an exemplary software configuration of the client PC 110 which constitutes the file management system. All functions of a file management system 200 according to the present exemplary embodiment are attained by a program executed on the client PC 110, as described in the hardware configuration in FIG. 1.

The file management system 200 includes a file system 206, a user input management module 205, a file storage module 203, a file search module 201, a screen display management module 204, and a file information acquisition module 202. The file system 206 stores and acquires information as a file to/from the hard disk 109 of the client PC 110.

The user input management module 205 detects a user's operation on the keyboard 108 and then instructs relevant modules to store a file and perform a file search operation according to the keyboard operation. The file storage module 203 instructs the file system 206 to store a file according to a storage instruction from the user input management module 205.

The file search module 201 instructs the file system 206 to acquire a file according to a search instruction from the user input management module 205, instructs the file information acquisition module 202 to acquire file information, and then instructs the screen display management module 204 to display a search result on the screen. Upon receipt of a display instruction from the file search module 201, the screen display management module 204 displays the search result on the display 107.

The file information acquisition module 202 receives an information acquisition instruction from the file search module 201 and then instructs the file system 206 to acquire file information, and transfers the file information acquired from the file system 206 to the file search module 201.

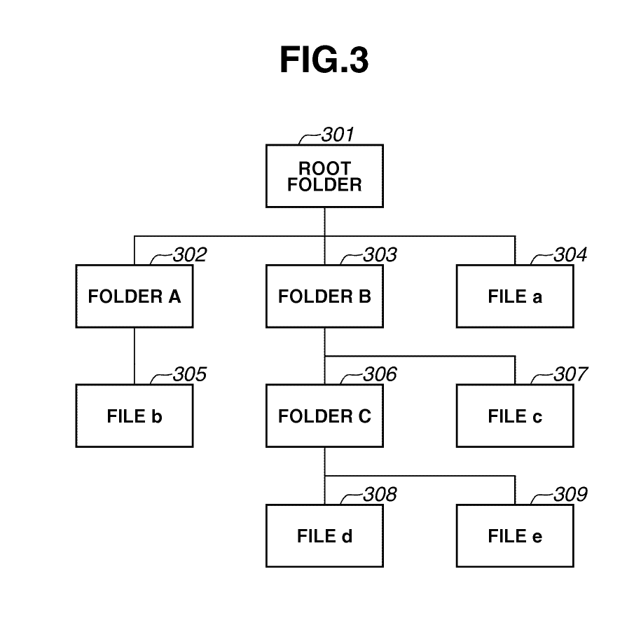

FIG. 3 schematically illustrates an exemplary data structure used for file storage in the file system 206. In the file system 206, files are stored with a tree structure (hierarchical structure) maintained. In the example illustrated in FIG. 3, a root folder 301 includes a folder A 302, a folder B 303, and a file a 304. The folder A 302 includes a file b 305. The folder B 303 includes a folder C 306 and a file c 307. The folder C 306 includes a file d 308 and a file e 309.

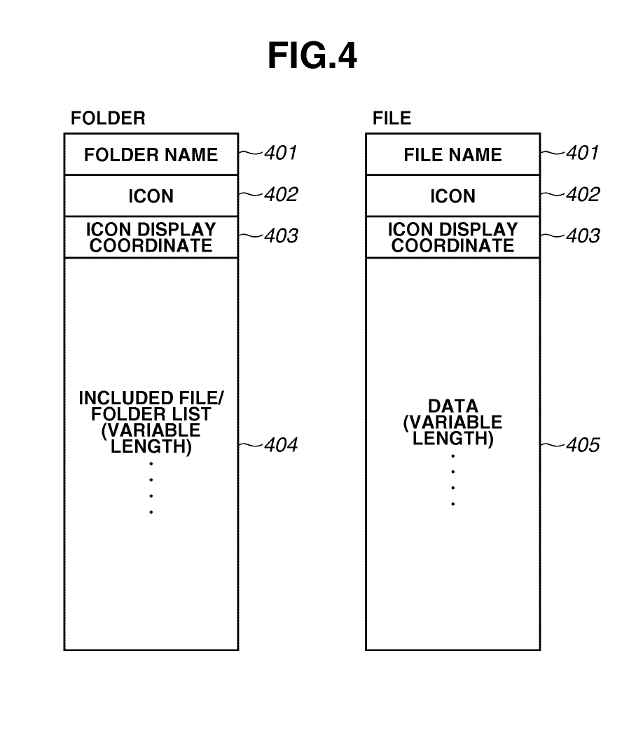

In the file system 206, a folder and a file have the data structures illustrated in FIG. 4. FIG. 4 illustrates an exemplary data structure of a folder and a file. A folder includes a folder name 401, an icon 402 used for screen display, an icon display coordinate 403, and an included file/folder list 404. The icon display coordinate 403 is an example of display coordinate information of the icon 402. The icon 402 is a small picture or symbol which indicates the contents and functions of data, for example, which is stored in the client PC 110.

The file system 206 includes one root folder 301. The tree structure can be attained by sequentially tracing the included file/folder list 404 of the root folders 301. A file has almost the same data structure as a folder, that is, a file name 401, an icon 402 used for screen display, an icon display coordinate 403, and stored data 405.

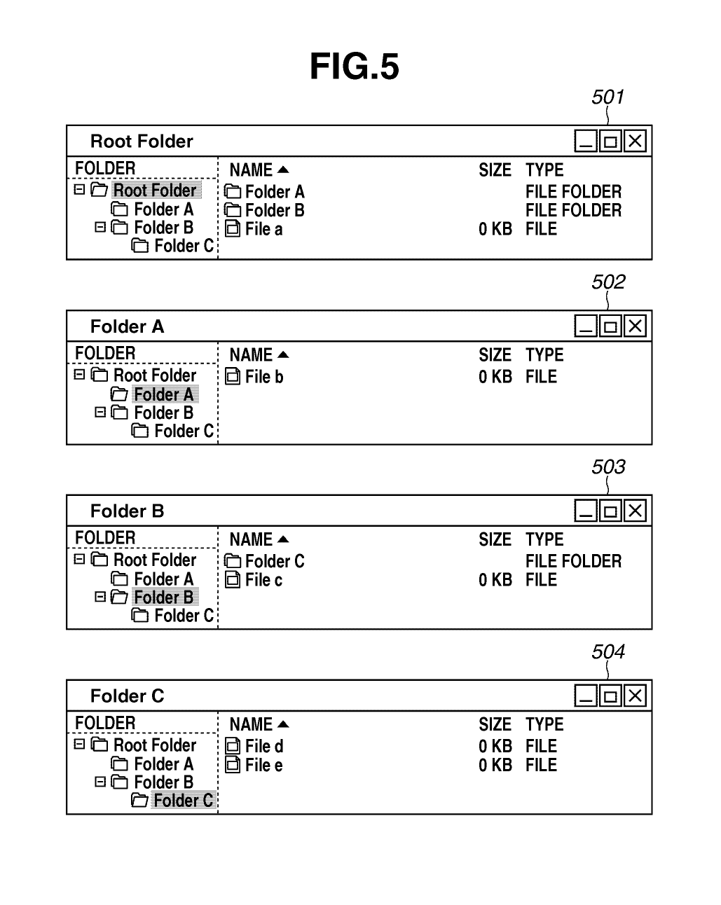

FIG. 5 illustrates exemplary screen display of each folder illustrated in FIG. 3 on the display 107 using a file operation module (not illustrated) in the file management system 200 in FIG. 2. When a user performs an operation to display the root folder 301, then the folder A 302, the folder B 303, and the file a 304 included in the root folder 301 are displayed based on the folder/file name 401, the icon 402, and the icon display coordinate 403, as illustrated in a screen 501 in FIG. 5. Likewise, the folder A 302, the folder B 303, and the folder C 306 are displayed as illustrated in a screen 502, a screen 503, and a screen 504, respectively, in FIG. 5.

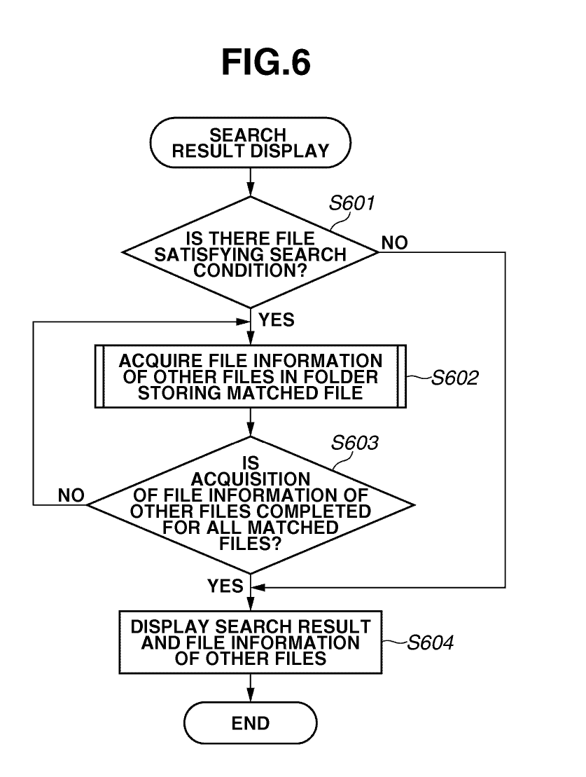

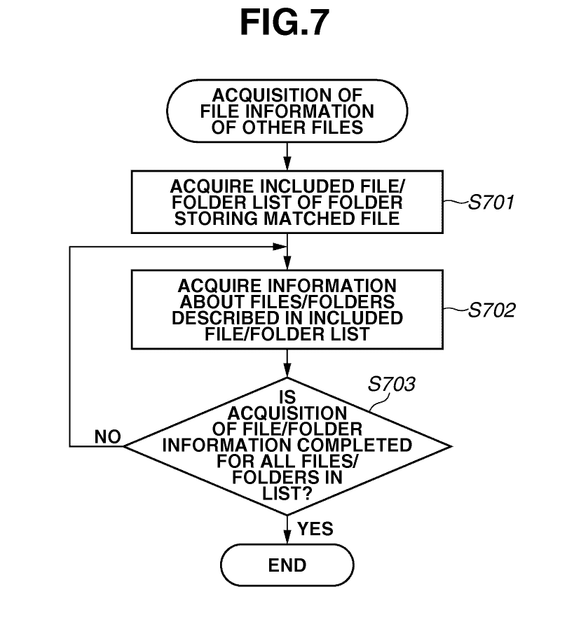

The flow of processing for file search and search result display by the file management system 200 will be described with reference to the software configuration in FIG. 2 and the flow charts in FIGS. 6 and 7.

FIG. 6 is a flow chart illustrating exemplary processing for file search and search result display. When the user performs a search operation on the keyboard 108, the user input management module 205 detects the operation on the keyboard 108 and then instructs the file search module 201 to perform a search operation including a search condition according to input via the keyboard operation. Upon receipt of the instruction, the file search module 201 acquires files from the file system 206, searches for a file which satisfies the search condition from the files managed by the file system 206, and acquires the file or information about the file (matched data information acquisition).

Upon completion of file search, the file search module 201 displays a search result. If there is no matched file which satisfies the search condition (No in step S601), then in step S604, the file search module 201 instructs the screen display management module 204 to display the search result to indicate that there is no matched file. Otherwise, if there is a matched file which satisfies the search condition (Yes in step S601), the file search module 201 instructs the file information acquisition module 202 to acquire file information of other files in a folder which includes each of matched files.

In step S602, the file search module 201 acquires the file information of other files via the file information acquisition module 202 (associated data information acquisition). A matched file is an example of matched data. Other files in the folder which includes the matched file are examples of associated data.

Detailed procedures for acquiring file information of other files (step S602) by the file information acquisition module 202 will be described below with reference to the flow chart in FIG. 7. FIG. 7 is a flow chart illustrating exemplary processing for acquiring file information of other files.

In step S701, the file information acquisition module 202 receives the information acquisition instruction from the file search module 201, instructs the file system 206 to acquire data for a folder which includes a matched file, and acquires data 404. In step S702, the file information acquisition module 202 instructs the file system 206 to acquire information about each file and folder described in the included file/folder list 404.

In step S703, the file information acquisition module 202 repeatedly performs the information acquisition (step S702) until information about all the files and folders described in the included file/folder list 404 is acquired. Although file information acquired by the present exemplary embodiment includes the folder/file name 401, the icon 402, and the icon display coordinate 403, the icon display coordinate 403 may not be acquired depending on contents of screen display of the search result to be described below. The folder/file name 401 is an exemplary data name.

Returning to the description of FIG. 6, in step S603, the file search module 201 repeatedly performs the information acquisition (step S602) until information about all files which satisfy the search condition is acquired. Then, based on the information about the acquired folder/file name 401, the icon 402, and the icon display coordinate 403, the file search module 201 instructs the file operation module (not illustrated) to create display (a screen) as a search result in which a matched file is selected (highlighted). This screen is the same as one used to display a folder which includes the matched file. In step S604, the file search module 201 instructs the screen display management module 204 to display the above-described search result screen.

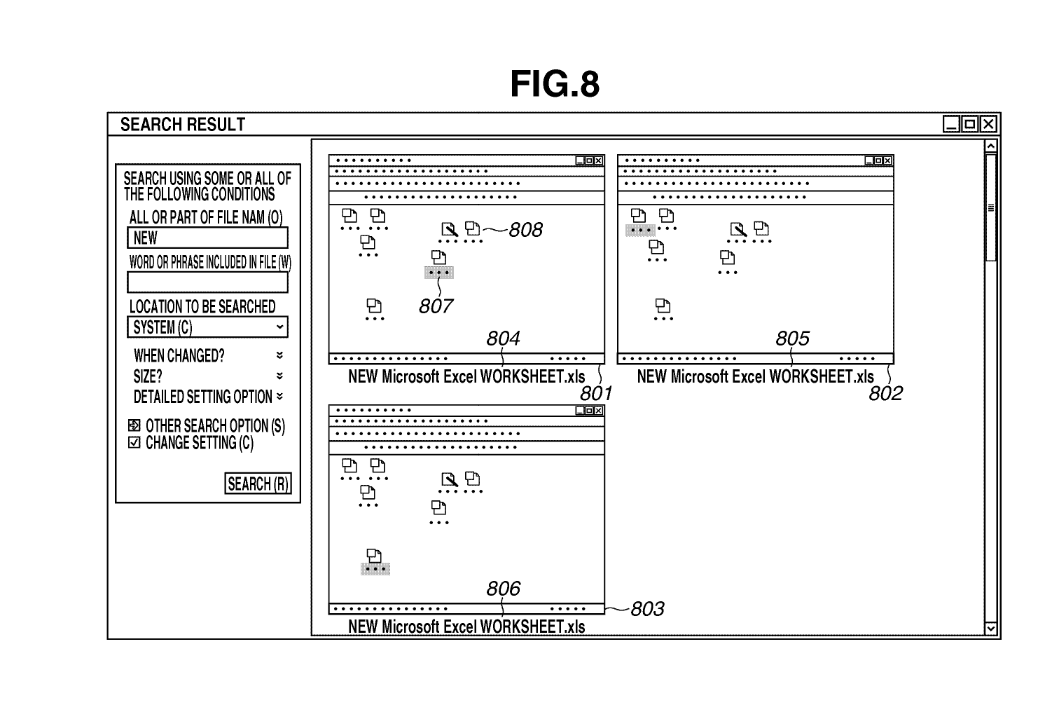

FIG. 8 schematically illustrates display of the search result created by the file search module 201. Three files 804, 805, and 806 which satisfy the search condition are displayed together with screens 801, 802, and 803 in which the matched files are selected. These screens are the same as ones used to display the folder which includes the matched file.

When display of the search result is described using the file 804 as an example, the screen 801 appears when a folder which includes the file 804 is displayed regardless of the search operation. An icon 807 indicates the file 804 and is highlighted as it is selected. Other files 808 in the folder which includes the file 804 are also displayed as icons. A relative display position of each icon within the screen 801 is the same as one used to display the folder which includes the file 804 regardless of the search operation.

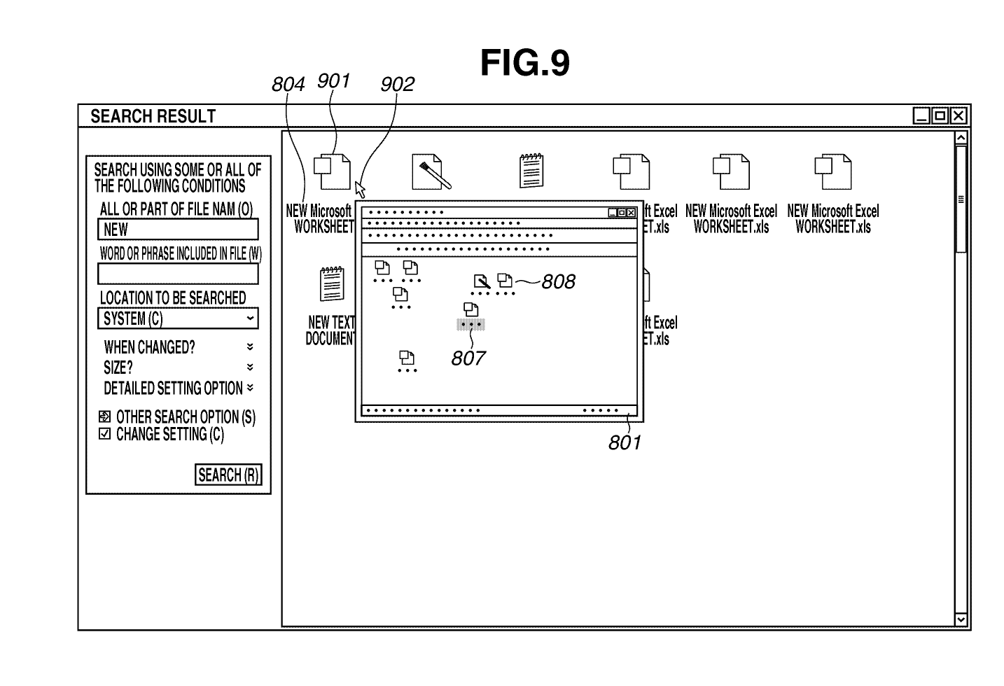

The search result can be displayed differently from the one in FIG. 8 according to display control to be described below. FIG. 9 schematically illustrates an exemplary search result displayed differently from the one in FIG. 8 by the file search module 201. In an initial state, the file search module 201 displays icons 901 of files which satisfy the search condition.

Only while a mouse pointer 902 is positioned at the icon 901 of the matched file by a user's operation, the file search module 201 displays the screen 801 in which the matched file 807 is highlighted. This screen is the same as one used to display the folder which includes the matched file 807. The mouse pointer 902 is a cursor which indicates an input position on an operation screen of the client PC or the like. It is an arrow-shaped symbol moving in response to a user's mouse operation. The mouse pointer 902 is not limited to an arrow.

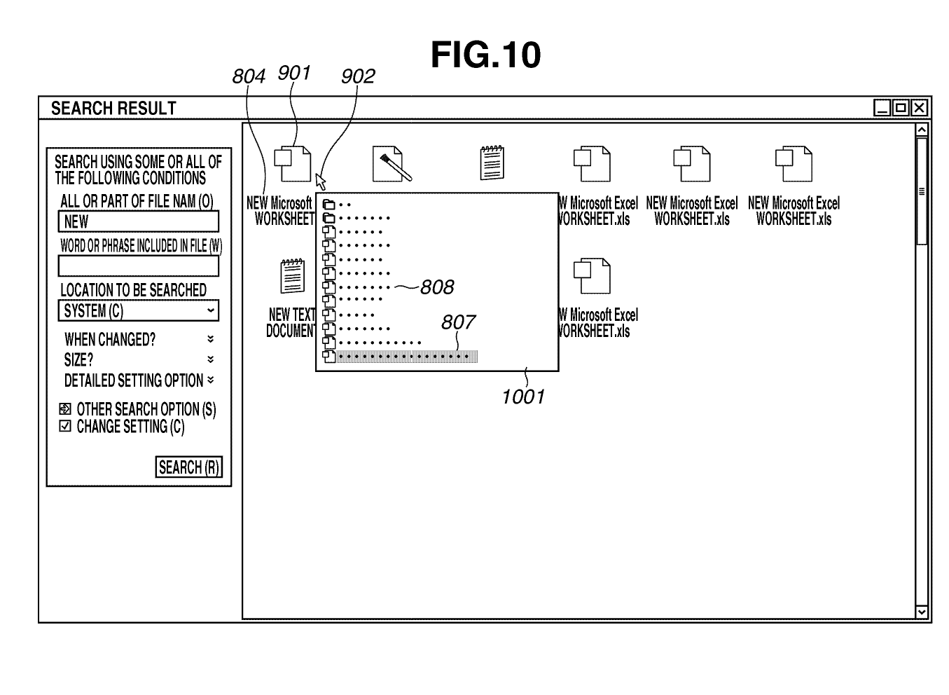

FIG. 10 schematically illustrates an exemplary search result displayed differently from the ones in FIGS. 8 and 9 by the file search module 201. In the initial state, the file search module 201 displays the icons 901 of files which satisfy the search condition, like the screen display in FIG. 9.

Only while the mouse pointer 902 is positioned at the icon 901 of the matched file by the user's operation, the file search module 201 displays a list 1001 in which the matched file 807 is highlighted. This list is the same as one used to display the folder which includes the matched file 807. As illustrated in FIG. 10, since the icon display position is meaningless when the search result is displayed in a list form, the icon display coordinate 403 may not be acquired in the above-described information acquisition (step S702).

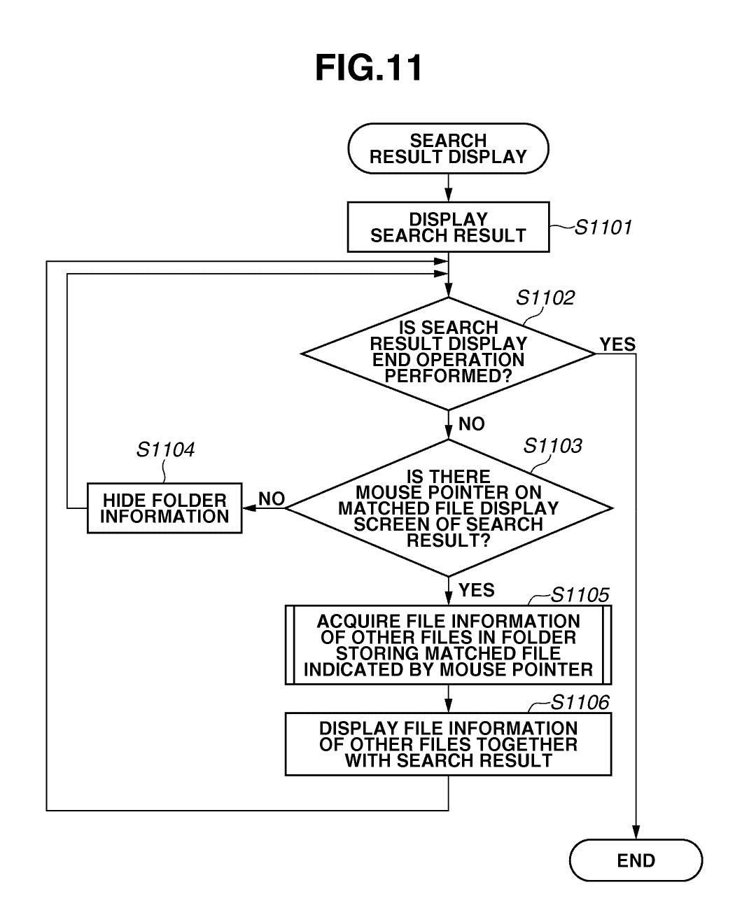

FIG. 11 is a flow chart illustrating exemplary processing for displaying the search result. In step S1101, the file search module 201 instructs the screen display management module 204 to display icons and file names of files which satisfy the search condition as the search result.

Then in step S1102, the user input management module 205 detects the user's operation and continues displaying the search result if termination of the search result display is not notified to the file search module 201 in response to the user's operation (NO in step S1102).

In step S1103, while the search result is being displayed, the user input management module 205 detects the user's mouse operation that has moved the mouse pointer 902 onto an icon of a file which satisfies the search condition. Then, the user input management module 205 notifies the file search module 201 of the fact that a certain matched file overlaps with a current mouse pointer position (Yes in step S1103).

In step S1105, the file search module 201 instructs the file information acquisition module 202 to acquire the file information about other files in the folder which includes the matched file.

The file information acquisition module 202 acquires the file information about other files in the folder which includes the matched file according to the processing in FIG. 7. Then, based on the acquired information, the file search module 201 instructs the file operation module (not illustrated) to create display (a screen) in which the matched file is selected. This screen is the same as one used to display the folder which includes the matched file. In step S1106, the file search module 201 instructs the screen display management module 204 to display the screen at the current mouse pointer position.

Likewise, in step S1103, while the search result is being displayed, the user input management module 205 detects the user's mouse operation that has moved the mouse pointer 902 from the icon of the file which satisfies the search result. Then, the user input management module 205 notifies the file search module 201 of the fact that the certain matched file no longer overlaps with the current mouse pointer position (No in step S1103).

In step S1104, the file search module 201 instructs the screen display management module 204 not to display the same screen as one used to display the folder which includes the matched file.

The above processing attains an operation for displaying the screens in which the matched file is selected, as illustrated in FIGS. 9 and 10, only while the mouse pointer is positioned at the matched file by the user's operation. These screens are the same as ones used to display the folder which includes the matched file.

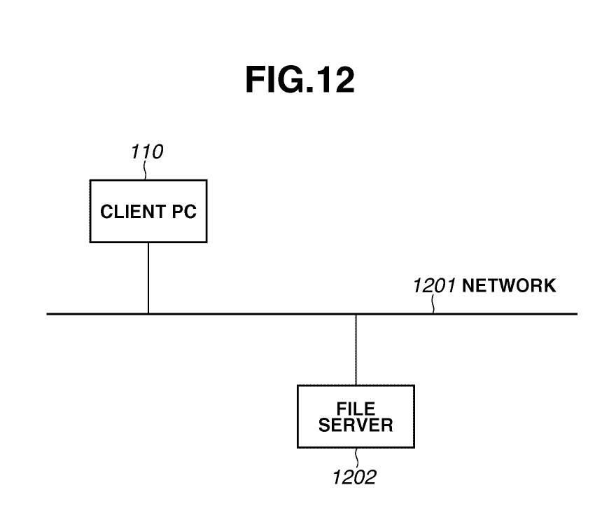

The system configuration of the file management system can also be attained by a client-server type system configuration configured by a plurality of information processing apparatuses (PCs). A system configuration of a second exemplary embodiment is illustrated in FIG. 12.

FIG. 12 illustrates an exemplary system configuration of the file management system. The client PC 110 and a file server 1202 which have the hardware configuration in FIG. 1 are connected to a network 1201 via a respective network controller 106.

Each of the client PC 110 and the file server 1202 according to the present exemplary embodiment has hardware configuration in FIG. 1.

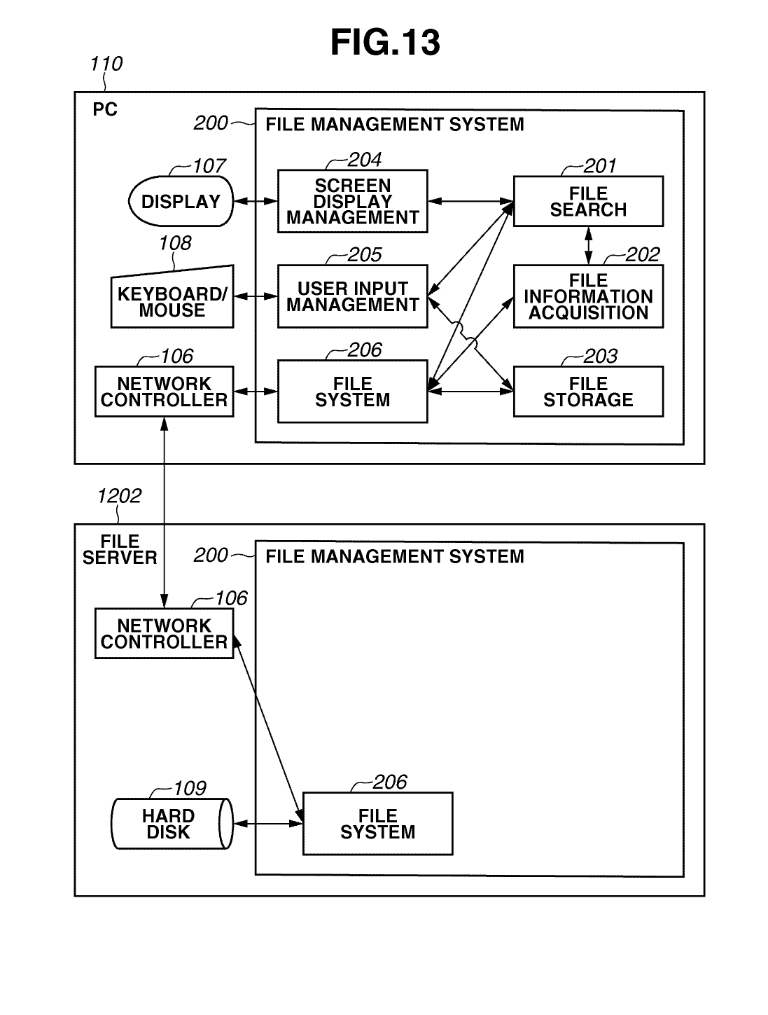

FIG. 13 illustrates an exemplary software configuration of the client PC 110 and the file server 1202 which constitute the file management system. The present exemplary embodiment differs from the first exemplary embodiment in that instructions to the file system 206 and data acquisition are performed via the network controller 106.

A file operation instruction to the file system 206 from the client PC 110 is transferred to the network controller 106 of the file server 1202 using a network (not illustrated) via the network controller 106 of the client PC 110. Then, the file system 206 of the file server 1202 performs actual processing.

When the file management system as shown in the present exemplary embodiment is attained by the client-server type file management system configured by a plurality of information processing apparatuses (PCs), the file system 206 can have a similar configuration to the first exemplary embodiment. However, with the present exemplary embodiment, a configuration attained by a database will be described as an example of other configurations.

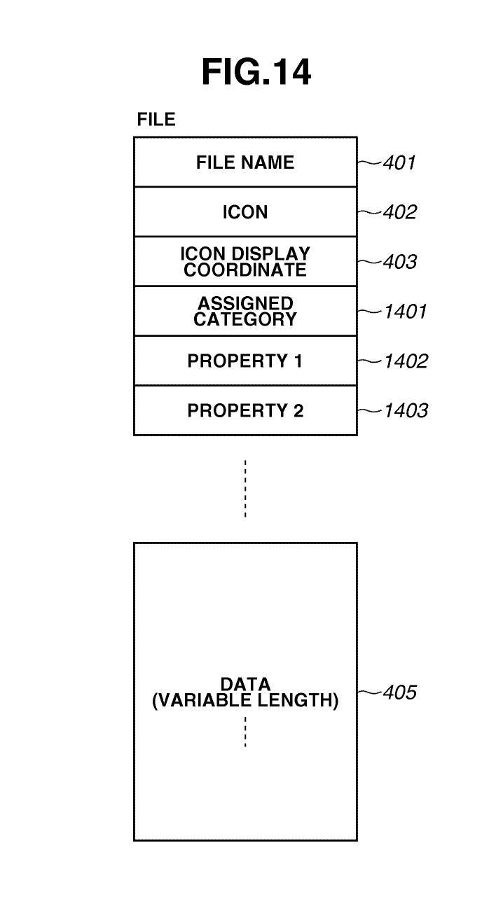

When the file system 206 performs a file operation based on a database, the data structure used for file storage has the structure illustrated in FIG. 14. FIG. 14 illustrates an exemplary data structure of a file.

Unlike the first exemplary embodiment, a file stored by the file system 206 is constituted from a set of property and data without forming a tree structure. Properties include a file name 401, an icon 402, an icon display coordinate 403, an assigned category 1401, a property 1 1402, and a property 2 1403.

The icon 402 is used when the file is displayed on the screen. The assigned category 1401 is equivalent to the folder name 401 of the first exemplary embodiment. The property 1 1402 and the property 2 1403 are data associated with the file.

The properties can include a variable number of items, so that a property 3, a property 4, and other additional pieces of information can be stored. A number of icon display coordinates 403 is not limited to one for each file and, with increasing number of users who accessed a file, the number of properties, such as the icon display coordinate for user A and the display coordinate for user B, also increases.

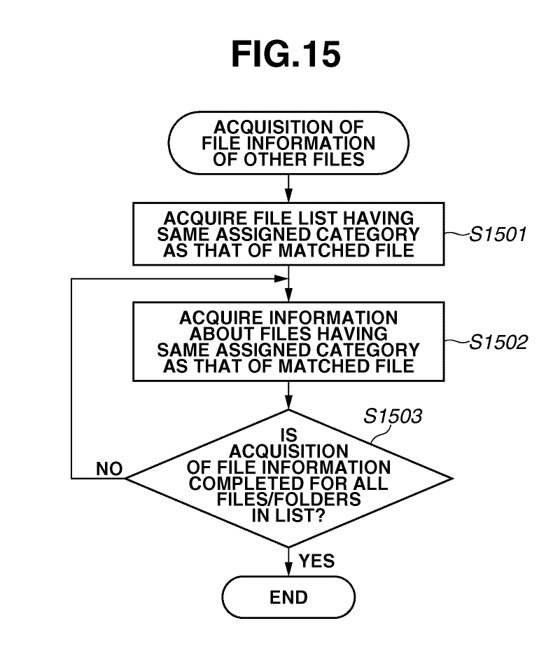

The present exemplary embodiment differs from the first exemplary embodiment in detailed procedures for acquiring file information of other files (step S602) in the file information acquisition module 202 shown in the flow chart in FIG. 7. The flow of processing for acquiring file information of other files will be described with reference to FIG. 15. FIG. 15 is a flow chart illustrating another exemplary processing for acquire file information of other files.

The file information acquisition module 202 receives an information acquisition instruction from the file search module 201 and then instructs the file system 206 to acquire a list of files which have the same assigned category 1401 as that of a matched file. In step S1501, the file information acquisition module 202 acquires a file list.

In step S1502, the file information acquisition module 202 instructs the file system 206 to acquire information about each file in the acquired file list.

In step S1503, the file information acquisition module 202 repeatedly performs the information acquisition (step S1502) until information about all files in the acquired file list is acquired.

The file information acquired in the processing includes the file name 401, the icon 402, and the icon display coordinate 403. An icon display coordinate of a user who operates the client PC 110 is acquired as the icon display coordinate 403. Subsequent display processing is similar to that of the first exemplary embodiment.

The above processing allows the file search module 201 to create a search result which is displayed differently for each user, and allows each user to display a screen in which a matched file is selected. This screen is the same as one used to display an assigned category in which the matched file is included.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-265790, filed Oct. 14, 2008, which is hereby incorporated by reference herein in its entirety.

What is claimed is:

1. An information processing apparatus comprising:
a matched data information acquisition unit configured to search for data stored in a storage device based on a search condition to acquire information about matched data which satisfies the search condition;
an associated data information acquisition unit configured to acquire information about associated data which is associated with the matched data; and
a display unit configured to display a screen which includes the information about the matched data acquired by the matched data information acquisition unit, and the information about the associated data acquired by the associated data information acquisition unit.

2. The information processing apparatus according to claim 1, wherein the associated data information acquisition unit acquires information about the associated data by recognizing data stored in the same folder in which the matched data is stored as the associated data.

3. The information processing apparatus according to claim 1, wherein the associated data information acquisition unit acquires an icon and a data name of the associated data as the information about the associated data.

4. The information processing apparatus according to claim 3, wherein
the associated data information acquisition unit further acquires display coordinate information about the icon of the associated data as the information about the associated data; and
the display unit includes the icon of the associated data in the screen based on the display coordinate information.

5. The information processing apparatus according to claim 1, wherein the display unit displays a screen which includes the information about the matched data acquired by the matched data information acquisition unit, and displays the information about the associated data acquired by the associated data information acquisition unit while a mouse pointer which moves in response to user's operation is pointing to the information about the matched data.

6. A method for information processing in an information processing apparatus, the method comprising:
searching for data stored in a storage device based on a search condition to acquire information about matched data which satisfies the search condition;
acquiring information about associated data which is associated with the matched data; and
displaying a screen which includes the information about the acquired matched data and the information about the acquired associated data.

7. A computer readable storage medium which stores a program for performing the method for information processing according to claim 6.
